(19) United States
(12) Patent Application Publication
(10) Pub. No.: US 2024/0328800 A1
(43) Pub. Date: Oct. 3, 2024

(54) ARTIFICIAL NEURAL NETWORK OPTIMIZED USER PROFILE-BASED JOURNEY PLANNING

(71) Applicant: BRAD E. LEWIS, PLEASANT SHADE, TN (US)

(72) Inventor: BRAD E. LEWIS, PLEASANT SHADE, TN (US)

(21) Appl. No.: 18/126,477

(22) Filed: Mar. 27, 2023

(51) Int. Cl. G01C 21/34; G06Q 10/047; G06Q 50/16

(52) U.S. Cl. CPC G01C 21/3484; G01C 21/343; G06Q 10/047; G06Q 50/16

(57) ABSTRACT

In one aspect, a computer system useful for implementing a language neutral virtual assistant provides a first data store of a plurality of historical user profile and a plurality of historical similar user profile data; uses the plurality of historical user profile data and the plurality of historical similar user profile data to train a user profile-based routing ML model; provides a second data store of another plurality of historical user profile and another plurality of historical similar user profile data; uses the other plurality of historical user profile data and the plurality of historical similar user profile data to validate the user profile-based routing ML model; obtains a set of tour stops; with at least one route planning and optimization algorithm, generates a tour route of the set of tour stops; uses the user profile-based routing ML model to identify a set of user profile affinity-based locations near the tour route; and generates an updated tour route that include a portion of the set of user profile affinity-based locations near the tour route.

### BACKGROUND

Journey planning is a specialized type of search engine that can be used to find an optimal means of travelling between two or more given locations, sometimes using more than one transport mode. Searches may be optimized on different criteria, for example fastest, shortest, fewest changes, cheapest. They may be constrained, for example, to leave or arrive at a certain time, to avoid certain waypoints, etc. However, current methods of journey planning and web mapping do not take into account various user profile information as well as information input by an agent interviewing the user. Accordingly, improvements to machine learning optimized user profile-based journey planning are desired.

### SUMMARY OF THE INVENTION

In one aspect, a computer system useful for implementing a language neutral virtual assistant provides a first data store of a plurality of historical user profile and a plurality of historical similar user profile data; uses the plurality of historical user profile data and the plurality of historical similar user profile data to train a user profile-based routing ML model; provides a second data store of another plurality of historical user profile and another plurality of historical similar user profile data; uses the other plurality of historical user profile data and the plurality of historical similar user profile data to validate the user profile-based routing ML model; obtains a set of tour stops; with at least one route planning and optimization algorithm, generates a tour route of the set of tour stops; uses the user profile-based routing ML model to identify a set of user profile affinity-based locations near the tour route; and generates an updated tour route that include a portion of the set of user profile affinity-based locations near the tour route.

### BRIEF DESCRIPTION OF THE DRAWINGS

FIG. 1 illustrates an example artificial neural network optimized user profile-based journey planning platform, according to some embodiments.

FIG. 2 illustrates an example schematic of a cloud-based real estate sales and purchasing platform, according to some embodiments.

FIG. 3 illustrates an example process for managing a mode of a real estate property tour tablet, according to some embodiments.

FIG. 4 illustrates an example process for optimizing user profile-based journey planning, according to some embodiments.

FIG. 5 is a block diagram of a sample computing environment that can be utilized to implement various embodiments.

FIG. 6 illustrates generation and use of user profile-based routing ANN model(s) to optimize route planner systems, according to some embodiments.

FIG. 7 illustrates an example process for tour planning and optimizations for ancillary lifestyle points of interest to user using route, according to some embodiments.

The Figures described above are a representative set and are not exhaustive with respect to embodying the invention.

### DESCRIPTION

Disclosed are a system, method, and article of manufacture for an artificial neural network optimized user profile-based journey planning. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment of the present invention. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided. This can be applied to the various embodiments discussed infra.

Application programming interface (API) can specify how software components of various systems interact with each other.

Bluetooth® is a wireless technology standard for exchanging data over short distances (using short-wavelength UHF radio waves in the ISM band from 2.4 to 2.485 GHz[3]) from fixed and mobile devices and building personal area networks (PANs).

Cloud computing can involve deploying groups of remote servers and/or software networks that allow centralized data storage and online access to computer services or resources. These groups of remote serves and/or software networks can be a collection of remote computing services.

Collaborative mapping, also known as citizen mapping, is the aggregation of Web mapping and user-generated content, from a group of individuals or entities, and can take several distinct forms. With the growth of technology for storing and sharing maps, collaborative maps have become competitors to third-party services (e.g. OpenStreetMap, Google Map Maker, Yandex.Map editor, etc.).

Deep learning is part of a broader family of machine learning methods based on artificial neural networks with representation learning. Learning can be supervised, semi-supervised or unsupervised. Deep-learning architectures such as deep neural networks, deep belief networks, deep reinforcement learning, recurrent neural networks, convolutional neural networks and transformers have been applied to fields including computer vision, speech recognition, natural language processing, machine translation, bioinformatics, drug design, medical image analysis, climate science, material inspection and board game programs, where they have produced results comparable to and in some cases surpassing human expert performance

K-nearest neighbors algorithm (k-NN) is a non-parametric supervised learning method. It is used for classification and regression. In both cases, the input consists of the k closest training examples in a data set. The output depends on whether k-NN is used for classification or regression. In k-NN classification, the output is a class membership. An object is classified by a plurality vote of its neighbors, with the object being assigned to the class most common among its k nearest neighbors (k is a positive integer, typically small). If k=1, then the object is simply assigned to the class of that single nearest neighbor. In k-NN regression, the output is the property value for the object. This value is the average of the values of k nearest neighbors. If k=1, then the output is simply assigned to the value of that single nearest neighbor. The training examples are vectors in a multidimensional feature space, each with a class label. The training phase of the algorithm consists only of storing the feature vectors and class labels of the training samples. In the classification phase, k is a user-defined constant, and an unlabeled vector (a query or test point) is classified by assigning the label which is most frequent among the k training samples nearest to that query point. In one example, used distance metric for continuous variables is Euclidean distance. For discrete variables, such as for text classification, another metric can be used, such as the overlap metric (or Hamming distance). In some examples, the classification accuracy of k-NN can be improved significantly if the distance metric is learned with specialized algorithms such as Large Margin Nearest Neighbor or Neighborhood components analysis.

Multiple listing service (MLS) can include a suite of services that real estate brokers use to establish contractual offers of cooperation and compensation (among brokers) and accumulate and disseminate information to enable appraisals. MLS's database and software can be used by real estate brokers in real estate representing sellers under a listing contract to widely share information about properties with other brokers who may represent potential buyers or wish to work with a seller's broker in finding a buyer for the property or asset. The listing data stored in a multiple listing service's database is the proprietary information of the broker who has obtained a listing agreement with a property's seller.

Mobile device can include a handheld computing device that includes an operating system (OS), and can run various types of application software, known as apps. Example handheld devices can also be equipped with various context sensors (e.g. biosensors, physical environmental sensors, etc.), digital cameras, Wi-Fi, Bluetooth, and/or GPS capabilities. Mobile devices can allow connections to the Internet and/or other Bluetooth-capable devices, such as an automobile, a wearable computing system and/or a microphone headset. Exemplary mobile devices can include smart phones, tablet computers, optical head-mounted display (OHMD), virtual reality head-mounted display, smart watches, other wearable computing systems, etc.

Nearest neighbor search (NNS) can be a form of proximity search, is the optimization problem of finding the point in a given set that is closest (e.g. or most similar) to a given point. Closeness can be expressed in terms of a dissimilarity function: the less similar the objects, the larger the function values. Formally, the nearest-neighbor (NN) search problem is defined as follows: given a set S of points in a space M and a query point q ∈ M, find the closest point in S to q. In one example, this can be a k-NN search, where the k closest points are found. M can be a metric space and dissimilarity is expressed as a distance metric, which is symmetric and satisfies the triangle inequality. M can be taken to be the d-dimensional vector space where dissimilarity is measured using the Euclidean distance, Manhattan distance or other distance metric. The dissimilarity function can be arbitrary as well.

Predictive Analytics includes the finding of patterns from data using mathematical models that predict future outcomes. Predictive analytics encompasses a variety of statistical techniques from data mining, predictive modelling, and machine learning, that analyze current and historical facts to make predictions about future or otherwise unknown events. In some examples, predictive models exploit patterns found in historical and transactional data to identify risks and opportunities. Models can capture relationships among many factors to allow assessment of risk or potential associated with a particular set of conditions, guiding decision-making for candidate transactions.

Representational state transfer (REST) is a software architectural style that was created to guide the design and development of the architecture for the World Wide Web. REST defines a set of constraints for how the architecture of an Internet-scale distributed hypermedia system, such as the Web, should behave. The REST architectural style emphasizes the scalability of interactions between components, uniform interfaces, independent deployment of components, and the creation of a layered architecture to facilitate caching components to reduce user-perceived latency, enforce security, and encapsulate legacy systems. RESTful web APIs are typically loosely based on HTTP methods to access resources via URL-encoded parameters and the use of JSON or XML to transmit data.

Real Estate Transaction Standard (RETS) data feed can be a raw data connection between a website and an MLS based using the Real Estate Transaction Standard. RETS can be used to import property listings and display them on a website. It is noted that other data feed and technology transfer types, such as, inter alia, Internet Data Exchange (IDX), FTP protocol, etc. can be utilized.

Route planner is a specialized search engine used to find an optimal means of travelling between two or more given locations, sometimes using more than one transport mode. Searches may be optimized on different criteria, for example fastest, shortest, fewest changes, cheapest. Searches can be constrained, for example, to leave or arrive at a certain time, to avoid certain waypoints, prioritize specified real estate properties, etc.

Vehicle routing problem (VRP) is a combinatorial optimization and integer programming problem which determines the optimal set of routes for a vehicle(s) to traverse in order to deliver to a given set of customers. VRP can be a generalization of the travelling salesman problem (TSP).

### Example Systems

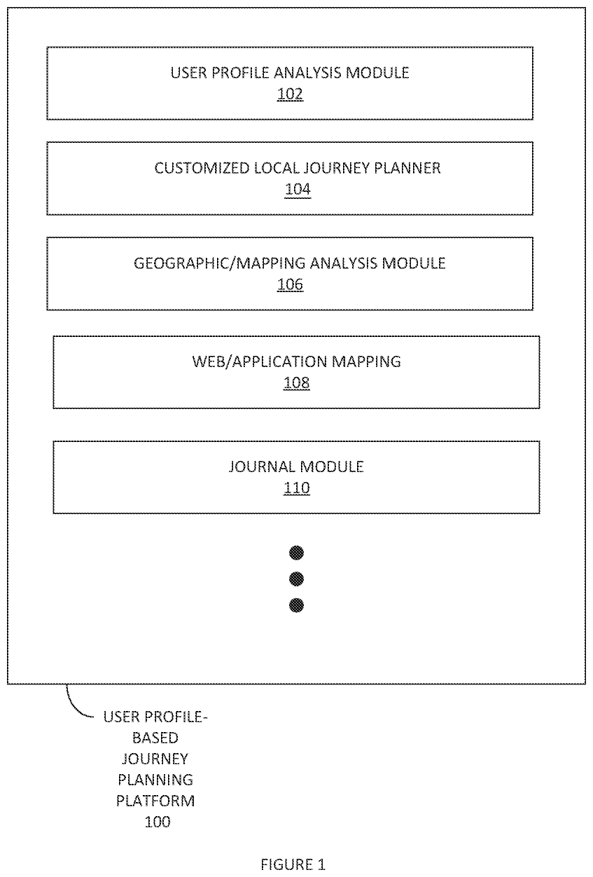

FIG. 1 illustrates an example artificial neural network optimized user profile-based journey planning platform 100, according to some embodiments. User profile analysis module 102 can obtain various user data. This can be from a user profile, user social media data, user survey data, user questionnaire input, etc. In one example, this data can be from an input from a subject matter expert (e.g. a local real estate agent, an educational professional, a medical professional, etc.) during an interview of the user. The interview can be regarding a journey to be taken by the user that is relevant to the subject matter expertise of the subject matter expert. For example, the subject matter expert can be a local real estate agent interviewing the user about various topics that can be related to a real estate journey plan. This can include obtaining information related to localities that rely on the specific knowledge of the real estate agent. User profile analysis module 102 can parse and analyze the input data in order to identify information relevant to a local real estate journey plan that is customized to the user's profile. For example, this can include a customized local journey plan that passes a golf course because the user has indicated he enjoys golf. In another example, this can include a local elementary school with a high rating because the user has indicated she has children of elementary school age. The data relevant to the customized local real estate journey plan can ranked and matched to various locations available to a journey plan parameters. In this way, instead of optimizing the customized local real estate journey plan based on such factors as fastest route, avoiding construction, etc., user profile-based journey planning platform 100 optimize the customized local real estate journey plan based on user-profile data such that it includes local sites of interest to the user. It is noted that user profile-based journey planning platform 100 can also include optimization for fastest routing and the like once the user-profile data parameters are satisfied.

Customized local journey planner 104 can make use of various data sets, including, inter alia: user profile data, real-time traffic data, construction data, weather data, cellular-reception data, etc. Customized local journey planner 104 can make use of various data sets improve the journey planning results. The journey planning results can be decorative, annotating the results with information about known incidents that might affect the trip, or computational. Customized local journey planner 104 can dynamically use a predicted departure and arrival times from a real-time feed. In some example, real-time feeds can include other journey plans of other users and/or agents (e.g. real estate agent) such that the journey plans of various users will not intersect/coincide at a location to be toured. Customized local journey planner 104 can use a service such as the CEN Service Interface for Real Time Information to give more accurate trip plans for trips taking place in the near future.

Customized local journey planner 104 can use various minimum inputs to a trip planner. These can include a list of locations to be toured, an origin and a destination. Other variables to be optimized (e.g. utilizing various machine learning models as discussed herein) include: place and a date and time of travel (which can be defaulted to the current moment). The interface (e.g. managed and served by the web/application mapping 108) can provide various methods to discover and specify an origin or destination, including specifying the name of a geocoded place, a stop or station code, a street address, a point of interest (e.g. a local attraction of interest to the user based on the user profile data, a tourist attraction and/or other named common destination, etc.) or a spatial coordinate (e.g. specified by using an interactive web map where current locations can also be obtained from a GPS location service or from an IP address lookup). A location finding function of customized local journey planner 104 can first resolve the origin and destination into the nearest known nodes on the transport network in order to compute a trip plan over its data set of known public transport journeys. Depending on the journey planning engine and the data sets (e.g. which include the ranked list of localities identified by the analysis of the user profile and/or explicitly input by the interviewing subject matter expert, etc.) which are available to it, many other additional inputs may be supported.

In some example, the additional inputs can include, inter alia: which transport modes to include or exclude; whether to constrain the time of travel by arrival time, departure time; whether to allow a flexible window within which travel may be undertaken; etc. Customized local journey planner 104 can utilize trip detour preferences for any preferred routing for the trip via intermediate stop/drive by points. Trip detour preferences can be local sites that are determined to appeal to a user based on a model of the user created by the user profile and/or subject matter expert inputs (e.g. input during the interview, etc.).

As noted supra, customized local journey planner 104 can route a journey/trip based on various optimization preferences. In one example, optimization preferences can include: a trip and tours local preferences based on user interests, subject matter expert inputs, the shortest trip versus the fewest changes. Customized local journey planner 104 can route a journey/trip based on trip cost optimization preferences (e.g. the cheapest versus the most convenient). Customized local journey planner 104 can route a journey/trip based on accessibility preferences (e.g. step-free, wheelchair accessible, etc.). Customized local journey planner 104 can route a journey/trip based on access preferences (e.g. how long the user is prepared to walk to a stop, etc.) . . . ). Customized local journey planner 104 can route a journey/trip based on type/class of travel (e.g. bicycle, car, bus, etc.) . . . ). Customized local journey planner 104 can route a journey/trip based on congestion preferences (e.g. least crowded versus shortest trip, etc.). Customized local journey planner 104 can route a journey/trip based on information relevant for selecting fares and the cheapest option (e.g. the type of user (adult, child, senior, student, etc.), ownership of travel cards, etc.).

Customized local journey planner 104 can route a journey/trip based on various nearest neighbor searches of other users with similarities to the user. A statistical classification search (e.g. k-NN, etc.) can be performed to match the user with other users. The interests of the statistically nearby users can also be recommended, ranked, and included in the trip/journey. If the subject matter expert is touring with the user, customized local journey planner 104 can prompt/alert the subject matter expert with an identification of the included local site along with relevant information explaining why the local site was included (e.g. based on the statistical classification search. For example, other users who liked a certain type of cuisine also like yoga studios. If though, the current user did not include yoga in their profile data, the statistical classification search can identify this as a local site to include the tour along with information about the local yoga studios the journey is including and/or passing by.

It is noted that customized local journey planner 104 can plan journeys/trips for both personal tours and business tours. For example, a user may be searching for a home to purchase or searching for a workshop or retail locations to rent. In a business example, customized local journey planner 104 can identify various services, locations, complimentary business, etc. that could be of use to the user's business and automatically include these in the journey/trip plan along with prompts with information about these sites of interest.

Outputs of the customized local journey planner 104 are now discussed. After customized local journey planner 104 has computed and prioritized a trip or set of possible trips, these are presented to the user as a list for the user to choose from, they may also or instead be displayed on a map (e.g. as provided by geographic/mapping analysis module 106). Depending on the capabilities of the planner and the available data, the results may include; the user-specific localities to tour/mention on tour, the times and departure points of the tour (e.g. when to arrive at and/or depart from a home for sale), instructions about touring a home or other space, information about the home or other space, etc. Customized local journey planner 104 can also provide, inter alia: other trip maps showing the path of the trip legs on a map; route maps showing the network topology; stop area maps and other directions to identify the location of the stops (e.g. users-specific points of interest, etc.; information about the heading signs shown on the vehicle in order to identify the correct transport vehicle to take; information on the transfer times needed to make the access and connection legs; step by step directions in order to follow an access leg to a stop, enter a station or large interchange such as an airport, or make a transfer on a connection leg, including the accessibility characteristics of each step; information on the accessibility characteristics of the vehicles on specific legs (wheelchair hoist, wheelchair spaces, etc.); information on the at-stop and on-board facilities (parking, buffet car, Wi-Fi, etc.); information on disruption or delays expected on specific trip legs or modes; etc.

In one example, customize local journey planner 104 can match user and/or subject matter specified inputs (e.g. demographic, lifestyle information, MLS data, etc.) with outputs (e.g. a ranked list of local sites of interest to the user, etc.). Customize local journey planner 104 can take these types of inputs and create a user profile. This user profile can be run be used to generate and train a machine-learned model (along with other historical user data such as that obtained from statistically similar past user profiles). The ML model can be used to determine which outputs are of the highest interest to user (e.g. by selecting highest rated inputs, if they are within a route deviation tolerance, adjusting route to include these points of interest, etc.).

Geographic/mapping analysis module 106 can include a web mapping service. In other examples, geographic/mapping analysis module 106 can leverage third party web mapping services. The data from the web mapping service can be fed to customized local journey planner 104. Geographic/mapping analysis module 106 can use maps (e.g. created through geographic information systems (GIS) on the Internet). A web map can be both served and consumed using various cartography functionalities to generate and/or update the web map. Once a journey/trip is generated by customized local journey planner 104, Geographic/mapping analysis module 106 can generate a customized web map to include the journey and the customized local sites. This customized web map can be fed to geographic/mapping analysis module 106.

Web/application mapping 108 can generate a user interface of the customized web map. Web/application mapping 108 provides and supports the web mapping visualizations experienced by the end user. Web/application mapping 108 also receives web map related inputs from the end user. These can be passed to the other modules of user profile based journey planning platform 100 to provide updates related to a current in use web map. Web/application mapping 108 can send the customized web map to the mobile device of the user and/or subject matter expert. The customized web map and a record of the user's journey and/or other interactions with the customized web map can be stored in a data store for future analysis, review and/or other uses (e.g. for future statistical similarity searches, etc.).

Machine-learning module 110 can utilize machine learning methods and systems to optimize the various outputs and models used by user profile-based journey planning platform 100. Machine-learning module 110 can utilize one or more machine learning process(es). Machine learning process(es) can manage and implement the various machine learning operations discussed herein. Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression, and other tasks, which operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, which is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. Finally, the test dataset is a dataset used to provide an unbiased evaluation of a final model fit on the training dataset. If the data in the test dataset has never been used in training (e.g. in cross-validation), the test dataset is also called a holdout dataset.

Front-end interface manager 112 can gather travel requirements from the user and present the proposed travel itineraries back to them, and a back-end journey planning engine which performs the actual computation of the possible trip plans, prioritizing these according to the user's optimization criteria (e.g. fastest, fewest changes, cheapest, etc.) and returning a subset that best satisfy them. The user interface may run on a terminal, PC, tablet, mobile device or even be speech based and may integrate maps and location data to give a visualization of the trip or to simplify the interaction with the user. The journey planning engine may be either local or remote and may have either a monolithic (all the data in a single search space) or a distributed architecture (the data for different regions split among different engines, each with their own search space). Front-end interface manager 112 can serve questionnaires, ask users, and subject matter experts (e.g. guides, real estate agents, teachers, etc.) questions via push messages in an application, etc. The data gathered by front-end interface manager 112 can then be fed back into user profile-based journey planning platform 100. It is noted that the web maps can be interactive and/or view only web maps. In some embodiments, the web maps can include one or more dynamic web map types, and static web map sources. These can include, inter alia: analytical web maps, maps with real-time animation (e.g. includes customized user-profile locations of interest, weather maps, traffic congestion maps, vehicle monitoring systems, etc.). Front-end interface manager 112 can provide and manage collaborative maps. In this way, a real-estate agent can manually update a customized web map in real time (e.g. assuming processing latencies, networking latencies, etc.) by adding new roads, new routes, points of interests specific to the interviewed client while the mobile device (e.g. a real estate property tour tablet, etc.) is in an agent mode, etc. In one example, a real estate agent can input the names of past clients that are to be used to weight the statistical similarity search discussed supra.

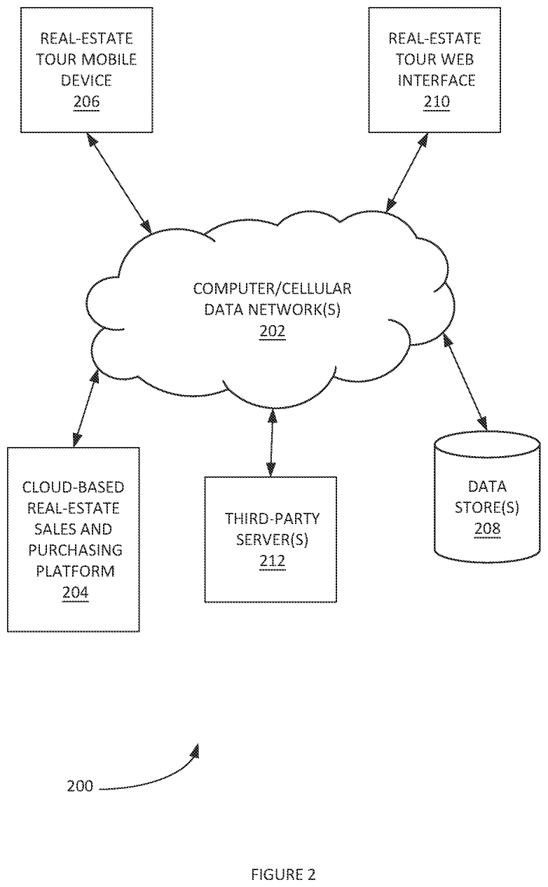

In some examples, optimized user profile-based journey planning platform 100 can be used in various journey planning functionalities. By way of example, an application of optimized user profile-based journey planning platform 100 to a cloud-based real estate sales and purchasing platform is discussed by way of example. FIG. 2 illustrates an example schematic of a cloud-based real estate sales and purchasing platform 200, according to some embodiments. Cloud-based real estate sales and purchasing platform 200 can enable a licensed real estate (RE) agents to use a client-side computing system (e.g. real estate tour mobile device 206, real estate tour web interface 210, etc.). Using the client-side computing system, the RE agent can open/create an account, upload personal/professional information, login to the cloud-based real estate sales and purchasing platform, generate tours, interface with a tour, access/search various MLS databases, etc.

RE agent can log in to cloud-based real estate sales and purchasing platform 204 with unique credentials (e.g. two factor authentication, bio-metric authentication, etc.). In this way, RE agent can access the functionalities and services of cloud-based real estate sales and purchasing platform 204. Cloud-based real estate sales and purchasing platform 204 can include one or more instances of user profile-based journey planning platform 100.

Real estate tour mobile device 206 can be a tablet computer and/or other type of mobile device (e.g. a real estate property tour tablet, etc.). Real estate tour mobile device 206 can include a real estate search and tour application. Real estate tour mobile device 206 can include Internet and/or cellular data connectivity (e.g. via Internet and/or cellular data network(s) 202, etc.). Real estate tour mobile device 206 can include various motion detector sensors that determine when real estate tour mobile device 206 is moving at a certain speed. Real estate search and tour application can include a series of tour modes (e.g. see infra) that can be toggled based on RE agent input and/or the state of real estate tour mobile device 206. Real estate search and tour application can manage a real estate tour, display of the real estate tour instructions/directions, uploading of the client notes/photos/videos, and/or communication of client information and notes to third parties (e.g. contractors, data analysts, etc.). Real estate search and tour application can enable local business to push notifications to clients who have toured near the local business. Real estate search and tour application can function and continue a real estate tour without Internet accessibility. Real estate search and tour application can detect an Internet connection and automatically upload data and refresh current real estate tour data.

The real estate tour display can include, inter alia: trip maps showing the path of the trip legs on a map, route maps showing the network topology, parking information, step by step driving instructions, information on disruption or delays expected on specific trip legs or modes, weather along route, etc. This information can be played by the tablet's (or other mobile device) audio system as well.

It is noted that real estate tour web interface 210 can also be used to access a web-version of real estate search and tour application. Additionally, real estate tour web interface 210 can be used by RE agents and others to register for the various services of system 200. Cloud-based real estate sales and purchasing platform 204 can manage the real estate search and tour application.

Cloud-based real estate sales and purchasing platform 204 can include various sub-systems. Cloud-based real estate sales and purchasing platform 204 can web servers, search engines, geo-fencing systems, geo-location servers, geo-mapping systems, client-management system(s), route planner(s), database management systems, e-mail servers, text/IM messaging servers, etc.

Cloud-based real estate sales and purchasing platform 204 can provide a property search engine that enables users to search for properties with a specified set of attributes (e.g. price, location, amenities, neighborhood characteristics, etc.). Cloud-based real estate sales and purchasing platform 204 can return search results. Search results can include, inter alia: value estimates of property, value changes of each home over a period, aerial views of properties, internal digital images/videos of properties, prices of comparable properties in a given geo-region, etc. The search result can also provide other information, such as, square footage, number of bedrooms and bathrooms, appliances, utilities, pools, etc. Users can also obtain estimates of homes that have undergone significant changes, such as a remodeled kitchen. It is noted that properties can include, inter alia: homes for purchase, retail buildings/offices for purchases, homes of rent, land, buildings/offices for rent, etc. Cloud-based real estate sales and purchasing platform 204 can provide MLS data in the search results as well.

Cloud-based real estate sales and purchasing platform 204 can connect RE agents and clients with various contract service providers. This can be done based on matching RE agent and/or client requests with specific services. Additionally, when a client has indicated a preference for a specified property a set of service providers that have skills appropriate to the needs of the property (e.g. a roofing service, a plumber, etc.) and/or context (e.g. local school system registrar, building inspectors, loan agencies, etc.) can be included in the data set sent to the client via the Cloud-based real estate sales and purchasing platform.

Cloud-based real estate sales and purchasing platform 204 can generate property tours based on user searches. The tours can include a route that includes a sequence of properties to be visited by a buyer RE agent and a client(s). Tour data can be displayed on the satellite imagery, aerial photography, street maps, 360° interactive panoramic views of streets (e.g. via a street view), real-time traffic conditions, and route planning for traveling by foot, car, and/or public transportation. A display of the tour can be a top-down view and/or a map view. The display can include streets, points of interest, etc. The view can include high-resolution imagery of cities as obtained by aerial photography in some selections.

Datastore(s) 208 can include various data stores utilized by. These can include one or more MLS databases managed by third parties. Datastore(s) 208 can include data that has been previously downloaded by cloud-based real estate sales and purchasing platform 204. Datastore(s) 208 can include data that has been uploaded by users (e.g. buyers, sellers, RE agents, contractors, geo-fenced tour sponsors, etc.).

Third-party server(s) 210 can include other servers managed by third parties. For example, third-party server(s) 210 can include geo-mapping servers, geo-fencing servers, e-mail servers, data management servers, etc. In this way, cloud-based real estate sales and purchasing platform 204 can off load some functionalities to third-party server(s) 210.

An example of a real estate tour is now discussed. An RE agent can search for properties for a client to tour (e.g. using a client using real estate tour mobile device 206, etc.). Based on criteria searching, the search results can include any number of properties to include on a real estate tour for buyers.

Cloud-based real estate sales and purchasing platform 204 can be tethered to a local MLS organization that the RE agent subscribes to cloud-based real estate sales and purchasing platform 204 already has a degree of info to pull into RE agent's profile (e.g. authenticate RE agent, etc.). RE agent can add to profile (e.g. photos, license #, affiliations with local MLS orgs, etc.). RE agent can create a unique and specific profile to his/her clientele.

It is noted that an RE agent can expand his/her profile within the “Agent Profile” functionality of the cloud-based sales and purchasing platform 204 to display additional features. Such features include an RE agent's ability to select certain details of the attributes. These details of attributes can be displayed on the tablet (and/or another mobile device). By selecting such attributes, the RE agent has the option to highlight specific attributes so that all of RE agent's clients can more easily identify said attributes during all client modes (e.g. the year the home was built, living space square footage, etc.).

Once RE agent creates an account in cloud-based real estate sales and purchasing platform 204, can create a profile for the client (e.g. digital photo, contact information, time frame expects client to make a purchase decision, etc.). It is noted that cloud-based real estate sales and purchasing platform 204 can include a CRM (client retention management) system that is part of platform.

The RE agent and/or client can conduct a search within the cloud-based real estate sales and purchasing platform 204 platform. It is noted that the data can be from a RETS web API IDX+ feed, authorized from various MLS organizations through the U.S./globally. MLS can have proprietary data for geographic zones (e.g. cities, counties, neighborhoods, etc.). When a property listing RE agent puts notes about the property (e.g. square footage, bathrooms, parking, room numbers, etc.). It is noted that the cloud-based real estate sales and purchasing platform 204 can display said notes in the RE agent and client-facing instances. Additionally, photos and videos of real estate property can be included. These can be put into a database and accessible by cloud-based real estate sales and purchasing platform 204.

Based on search results, the RE agent can select which properties in MLS data search to include on the tour. Cloud-based real estate sales and purchasing platform 204 sends a data fetch to local MLS database and then receives all the data into platform. This data is also stored in the cloud-based real estate sales and purchasing platform 204. The properties are selected for client to tour and review. This can be accessed by a mobile device and/or desk top computing systems. It is noted that the cloud-based real estate sales and purchasing platform 204 can refresh the data fetch from the MLS data source at set intervals (e.g. 1 second, etc.). Accordingly, it can overwrite data on all the previous properties.

At this point, a RE agent has a tablet (e.g. real estate tour mobile device 206, etc.) with a kiosk mode that allows only for a real estate search and tour application. Tablet only interfaces with cloud-based real estate sales and purchasing platform 204 and is able to connect to Internet. The RE agent(s) can login in and be authenticated by cloud-based real estate sales and purchasing platform 204 and granted access to agent's database to their clientele and tours that they have previously created. The RE agent can review roster of client tours, directions, etc.

While the RE agent is reviewing (e.g. via a web interface) the agent's client tours: the agent sets date of tour, then on a property-by-property basis that are to be shown to client, agent clicks on property and sets a time for the property tour. When the RE agent clicks a virtual button in the application display, the cloud-based real estate sales and purchasing platform 204 then obtains a database of who is representing seller of the property and their contact information, when the property is to be shown, etc. This data is gathered and can be sent in real time to the sellers' agent to confirm time/date for showing. This communication channel can be kept open by cloud-based real estate sales and purchasing platform 204 such that tours can be coordinated and validated with sellers' agent. The sellers' agent can confirm tour time, decline tour time and/or recommend another tour time.

The buyer agent can receive a communication via email and/or text (e.g. outside platform) as well as within platform (e.g. via push notification) of the seller agent status/confirmation(s) (e.g. acceptance, declined, alternative dates/times, etc.).

The buyer agent can review possible tours for clients (e.g. as arranged by platform based on seller agent feedback). The buyer agent can select the tour to interact with, preview tour (e.g. a sequence of properties that displayed on an interactive map), update routes, etc. The buyer agent can click on property icons to view live/current MLS database data of the property (e.g. videos, photo, notes, etc.). The buyer agent can dynamically modify tours as well using the platform interface. In this way, the buyer agent can select a series of properties to tour, automatically obtain seller agent permissions, and/or select property information to be shared with the client associated with the tour.

The buyer agent can exit agent mode and prompt table to enter client mode. The client can use a client mode to preview tour and interact with the map, property/listing information, etc. The tablet (or mobile device) can then be set into tour mode. In tour mode, the tablet (or mobile device) is independent of an internet connection. It can still use a GPS satellite connection if needed (e.g. via an internal GPS chip). The tablet (or mobile device) can also include a CDMI chip that enables the device OS to know it is in motion. Once the tablet (or mobile device) detects it is in a series of motions related to a tour, it can automatically switch into an on-route mode.

In on-route mode, the tablet screen displays a map of the route and current location of the tablet. Additionally, cloud-based real estate sales and purchasing platform 204 can implement geo-fencing operations. A network and a series of local points of interest with each geo-fenced area are automatically included. This can include, inter alia: parks, businesses, schools, amenities, churches, EMS services, hospitals, etc. Details of each of these can be made available to user (e.g. by clicking/tapping on an icon of the local point of interest, etc.). This can familiarize clients with the various points of interest with each geo-zone the tour passes through.

An affiliate networking model can enable the local business owners with a geo-fence. Offerings can be automatically pushed to clients on tour. For example, coupons can be sent to clients for a restaurant.

The buyer agent and client interaction with the tablet (and/or other mobile device) during the tour can be stored as well for later analysis. The information that is provided to the client is stored. In this way, a record of the client's tour is stored.

Once the tablet (and/or other mobile device) reaches a property, it automatically switches from on-route mode to tour mode. In tour mode, the screen displays the property information (e.g. current MLS data when left for tour). The camera is also activated for client to take videos and photos of the home. A star rating system can be provided to receive feedback from client. Clients can utilize a favorite feature to note favorite properties. Client notes can be obtained via the tablet (e.g. typed notes, voice memos, etc.). Clients can input the notes in an open field comment input section. These can also be stored. In this way, the client perspective can be obtained and reviewed for later analysis.

It is noted that the tour can be exported to other entities for review and analysis. Once tablet enters a traveling motion, it can dynamically return to on-route mode and the tour can continue. This cycle can repeat until all the properties on the specific tour are completed. RE agents can add/edit properties on tour as well on the fly. Once the tour is complete, the mobile device can be unlocked by the RE agent from client mode and returned to agent mode.

The buyer agent can export tour. This can include all the MLS data when tour began, per property notes/videos/favorites/photos/etc. All points of interest and local merchant offers can be exported as well. The export can be exported to additional recipients on client request (e.g. export to a client's spouse, contractors, etc.). It is noted that this data can be automatically sent to the buyer at an export event. The data set can also contain relevant contact information and respective regulatory identifiers. In one example, an agent's state/national professional license number, etc. can be used. This exported tour data can also remain on the cloud-based real estate sales and purchasing platform 204 so that it can be accessed in future.

Property buying tips can be prompted to clients during the tour (e.g. reminders of property-buying behaviors to focus on, recommendation for photos of areas on concern for inspectors, etc.). Dimensions for standard furniture and furnishings may be displayed. A method for obtaining measurements of the existing space in the home may be accessed by the user during the property tour. This can be provided in a tool bar of the display. A floor plan estimator tool can be provided. This can be used to estimate square footage of rooms. The data from the real estate search and tour application can be exported as well as the data the user accessed during the tour (e.g. that the dimensions of a king-sized bed were obtained while touring a property address with 123 Anywhere St was accessed during the tour, etc.). In this way, the data can serve as a reminder to the client that they had referenced that data during the tour.

Clients can review exported data at a later time as well as share it. The client can receive the exported data in the form of a formatted report that is accessible via a hyperlink. The tour data which is contained in the exported report is sent from the mobile device to the cloud-based real estate sales and purchasing platform once an internet connection is re-obtained by the mobile device. Until that time, the data can be stored locally on the mobile device.

At the end of tour, the buyer agent is prompted to request additional data to update client profile. This can include, inter alia: clients need for inspector assistance, financing referrals, contractor referrals, etc.

### Example Methods

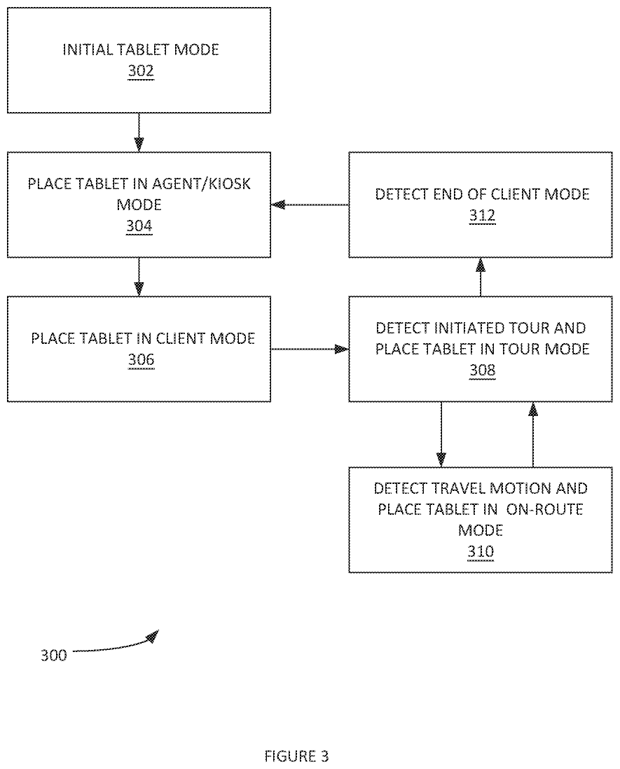

FIG. 3 illustrates an example process 300 for managing a mode of a real estate property tour tablet, according to some embodiments. In step 302, process 300 can place a tablet computer in an initial mode. The various modes of process 300 are discussed supra. In step 304, process 300 can place tablet in agent/kiosk mode. This mode enables agent input. In step 306, process 300 can place tablet in client mode. In this mode, the tablet can receive client input and display data relevant to the client experience. In step 308, process 300 can detect initiated tour and place tablet in tour mode. In step 310, process 300 can detect travel motion and place tablet in on route mode. In step 312, process 300 can detect the end of client mode. Accordingly, the tablet or other mobile device can revert to agent mode upon entry of the agent's unique credentials.

An example set of mode states are now discussed. In one example, kiosk mode can be used to render the mobile device useless but for the ability to access our software. Tablets (and/or other mobile devices) utilized by cloud-based real estate sales and purchasing platform 104 can initially be locked in a kiosk mode. Accordingly, the users, agents, and clients alike, can only be able to use the mobile device for cloud-based real estate sales and purchasing platform 104 activities.

Agent mode can be differentiated from client mode in that the agent is able to select which of his tours (created over the web-interface) he wants the tablet (and/or other mobile device) to display, edit the tour and place it into/out of client mode. In client mode, the client is only able to access their respective tour data.

### Additional Embodiments

In one example, a real estate property tour tablet can create an environment where a salesperson or consultant can collect data pertaining to lifestyle preferences of a consumer or consultee arranged in a client profile interface and computer learning shall reference said data in arranging navigational routes which ultimately lead to a specific destination where consumer or consultee shall be able to physically experience an item of their potential interest. Whereby such route shall also direct the consumer or consultee via various points of interest at specific geographical locations commensurate with the lifestyle preferences attributed to the client profile interface. The same technology shall trigger an onscreen notification to the mobile device which is tethered to the real estate property tour tablet software immediately and at once when that device enters into a specific geofenced radius of each point of interest.

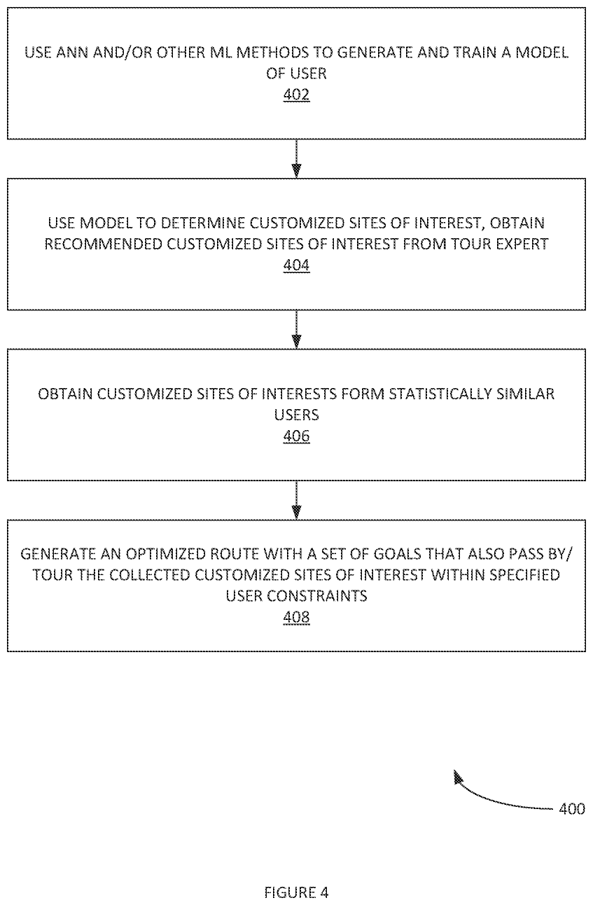

FIG. 4 illustrates an example process 400 for optimizing user profile-based journey planning, according to some embodiments. In step 402, process 400 can use ANN and/or other ML methods to generate and train a model of user. The model can provide a set of local sites within a geographic boundary of a journey that have a specified probability of being of interest to the user. As noted supra, various datasets can be used to train the user's journal model. These can include, inter alia: user profile data, user demographic data, user spouse profile data, user educational data, user answers to an intake questionnaire, data input by an agent interviewing the user, etc.

In step 404, process 400 can use a model to determine customized sites of interest, obtain recommended customized sites of interest from tour expert. In step 406, process 400 can obtain customized sites of interests from statistically similar users (e.g. datastores 602-604, 610-612, etc.). The other users can have profiles based on, inter alia: other users' profile data, other users' demographic data, other users' spouse profile data, other users' educational data, other users' answers to an intake questionnaire, data input by an agent interviewing the other users, feedback data from other users, performance data of other users (e.g. other users stopped/tour the included local site of interest), etc. This data can be quantified utilized in statistical similarity tests such as nearest neighbor searches (e.g. can be k-NN analysis, etc.). Other prediction methods can be used to rank and/or otherwise enhance the results of step 406.

In step 408, process 400 can generate an optimized route with a set of goals (e.g. homes to tour) that also pass by/tour the collected customized sites of interest within specified user constraints (e.g. time constraints, etc.).

### Example Computer Architecture and Systems

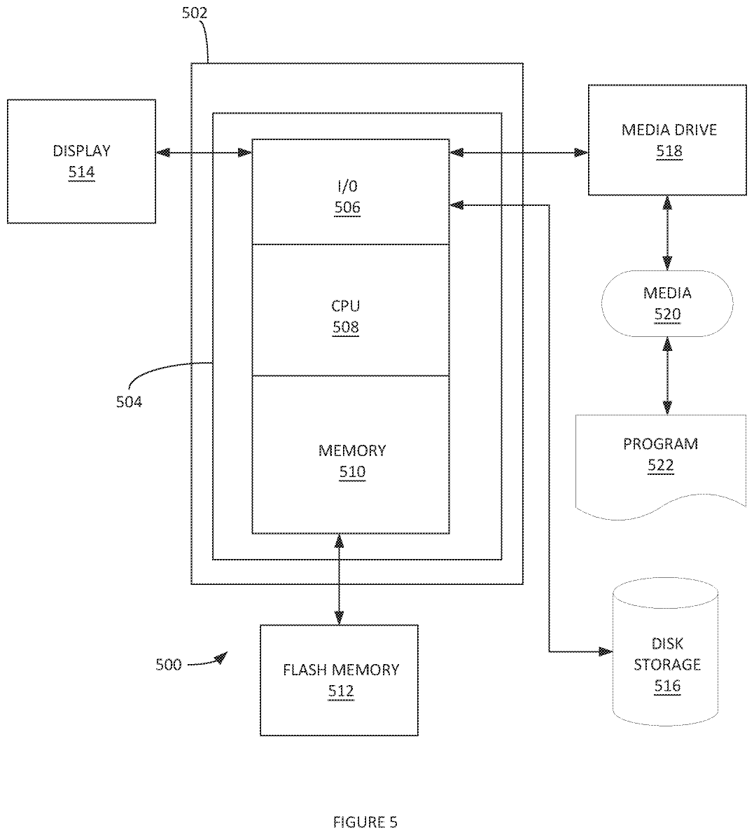

FIG. 5 depicts an exemplary computing system 500 that can be configured to perform any one of the processes provided herein. In this context, computing system 500 may include, for example, a processor, memory, storage, and I/O devices (e.g., monitor, keyboard, disk drive, Internet connection, etc.). However, computing system 500 may include circuitry or other specialized hardware for carrying out some or all aspects of the processes. In some operational settings, computing system 500 may be configured as a system that includes one or more units, each of which is configured to carry out some aspects of the processes either in software, hardware, or some combination thereof.

FIG. 5 depicts computing system 500 with a number of components that may be used to perform any of the processes described herein. The main system 502 includes a motherboard 504 having an I/O section 506, one or more central processing units (CPU) 508, and a memory section 510, which may have a flash memory card 512 related to it. The I/O section 506 can be connected to a display 514, a keyboard and/or other user input (not shown), a disk storage unit 516, and a media drive unit 518. The media drive unit 518 can read/write a computer-readable medium 520, which can contain programs 522 and/or data. Computing system 500 can include a web browser. Moreover, it is noted that computing system 500 can be configured to include additional systems in order to fulfill various functionalities. Computing system 500 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

Aspects of another example embodiment are now discussed. Cloud-based real estate sales and purchasing platform 104 can include a client management system. This can be used to confirm a tour time on a property-by-property basis. A realtor can see client entry data/review of property preview tour summary before sending the client out on the tour. When the client leaves on the tour, the real estate property tour tablet can then switch to the client mode. It is note that during client mode, the real estate property tour tablet locks the client out from accessing/seeing other information (e.g. other client data, etc.). The real estate property tour tablet point out various points of interest. The real estate property tour tablet can present thought bubbles announcing a point of interest to the client. These points of interest can be based on the client's profile/interest. In one example, as the client drives through a geo-fenced circle a set of specified thought bubbles can appear. Geofencing methods and systems can be used to detect when to display local points of interest in real-time on the screen.

The real estate property tour tablet detects when within a geofence of property to be toured has been entered. The mode of real estate property tour tablet can be automatically updated and the real estate property tour tablet changes views. During the property tour, clients can give rating (e.g. 3 of 5 starts), input text reviews/comments etc. These ratings can be for whole property or for elements of property. The client can take a photo/video and include in review, etc.

Continuing with the present example, when the client starts driving to next property (i.e. left that first property's geofence), the real estate property tour tablet can return to tour mode. The real estate property tour tablet can mirror/connect/integrate property details view with client observations/inputs/feed of property rinse and repeat key points of novelty-tour summary-points of interest systems-geofencing controlling mode of the real estate property tour tablet modes and returning to tour mode real estate not real estate client management system, confirm tour time on a property by property basis realtor can see client entry data/review of property preview tour summary before send client out then switch to client modes-locks out from client seeing other information (e.g. other client data, etc.).

The real estate property tour tablet can utilize geofencing to also provide various ‘pro-tips’ popping up with a thought bubble. These can alert clients to look for certain issues related to the touring and purchasing of a property of a specified type (e.g. double check roof, look for mold in bathroom, etc.). A client can share the tips, notes, and pictures with specified service professionals. For example, a photo of a roof can be shared with a home inspector.

It is noted that the real estate property tour tablet can function entirely offline once the data fetched. Offline functionalities that are available include, inter alia: mapping tiles, routes, locations to be toured, uploads/notes from clients, etc.

### Additional Machine Learning Technques for Optimized User Profile-Based Journey Planning and VRP

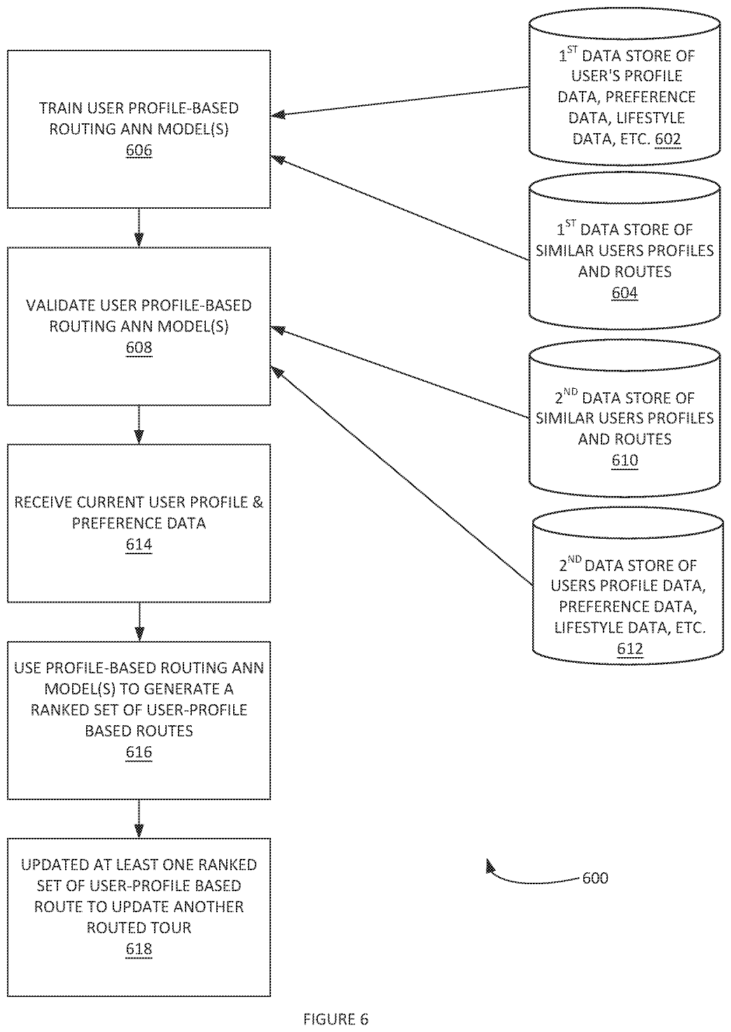

FIG. 6 illustrates generation and use of user profile-based routing ANN model(s) to optimize route planner systems, according to some embodiments. In step 606, process 600 can train user profile-based routing ANN model(s). Here, process 600 can use various data for training. These can include, inter alia: a 1st data store of users profile data, preference data, lifestyle data, etc. 602, a 1st data store of similar users profiles and routes 604, etc.

In step 608, process 600 can validate user profile-based routing ANN model(s). Here, process 600 can validate using, inter alia: 2nd data store of similar users profiles and routes 608 2nd data store of users profile data, preference data, lifestyle data, etc. 610 updated at least one ranked set of user-profile based route to update another routed tour 616, etc. Validation steps can include running various scenarios with the user profile-based routing ANN model(s) and scoring results based on such factors and

In step 614, process 60 can receive current user profile and preference data. In Process 600 can use profile-based routing ANN model(s) to generate a ranked set of user-profile based routes in step 616. Process 600 can update at least one ranked set of user-profile based route to update another routed tour in step 618.

In this way, a user's set of “Lifestyle Points of Interest” (e.g. set of user profile affinity-based locations, etc.) can appear during an ideal route for the buyers. These “Lifestyle Points of Interest” can be ancillary to the tour's purpose (e.g. tour's purpose can be a tour of real estate destinations and “Lifestyle Points of Interest” can be a set of schools, gyms, churches, restaurants, etc. that fit the user's interests/lifestyle). The “Lifestyle Points of Interest” can be complimentary data once may consider while in the decision-making process of the purchase cycle. It is noted that process 600 can use deep learning methods with/in addition to ANN methods. In this example, “Lifestyle Points of Interest” of other similar users can be identified and used to train predictive and/or routing models. For example, “Lifestyle Points of Interest” of similar users can be included in data stores 602-604 and 610-612.

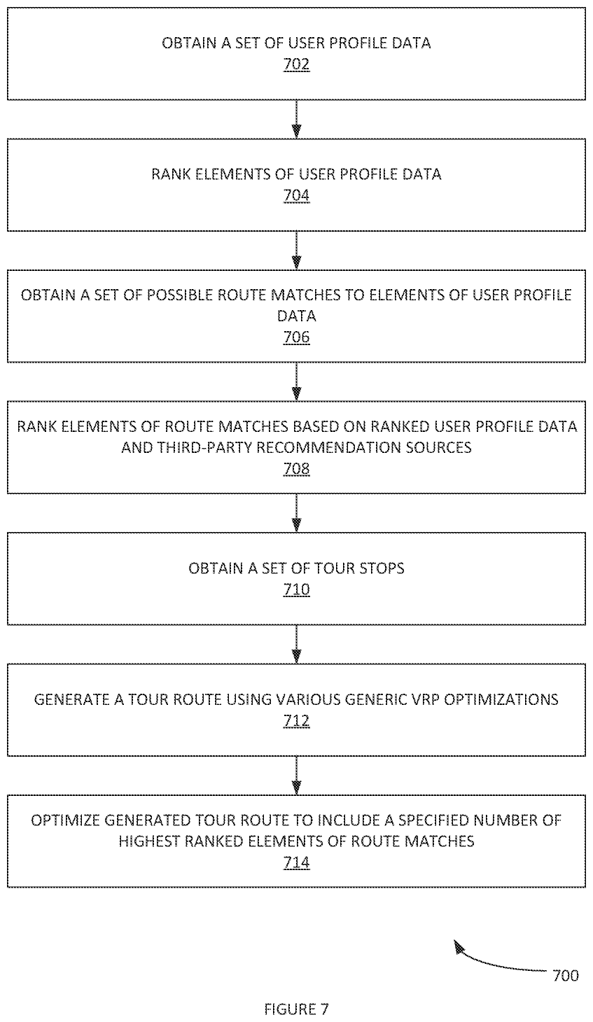

FIG. 7 illustrates an example process 700 for tour planning and optimizations for ancillary lifestyle points of interest to user using route, according to some embodiments. In step 702, process 700 can obtain a set of user profile data (e.g. user favorite activities, user family structure, activities of user's children, user favorite food/restaurant types, user favorite sports activities, user hobbies, user workplaces, user religious activities, user health activities, etc.). These can be used for “Lifestyle points of interest”. In step 704, process 700 can rank elements of user profile data.

In step 706, process 700 can obtain a set of possible route matches to elements of user profile data. In step 708, process 700 can rank elements of route matches based on ranked user profile data and third-party recommendation sources (e.g. publish crowd-sourced reviews about businesses websites, table reservation web sites, third-party expert review websites, subject matter expert review websites, etc.).

In step 710, process 700 can obtain a set of tour stops. It is noted that the tour purpose is unrelated to rank elements of route matches. The rank elements of route matches can be “Lifestyle Points of Interest” that are ancillary and/or complimentary to the purpose of the tour. In step 712, process 700 can generate a tour route using various generic VRP optimizations. In one example, step 712 can plot geo-locations in close proximity to a pre-determined route whereby the user can be notified of their close, physical proximity (e.g. utilizing geo-fencing techniques) while the user travels along the pre-determined route. The users can retain option to drive down a more direct route to their tour stops. The touring application can place POI beacons (e.g. “Lifestyle Points of Interest”) that can appear in the navigation informing them there is a point of interest that they may be interested in close proximity.

That way we can give the agent the option to tap “Stay on direct route” or “Take the POI Route” based on how much time they may have with their client.

The VRP optimizations can optimize the tour's route planning to ensure the tour is on time. The VRP optimizations can ensure tour leaders (e.g. a real estate agent, etc.) are not rushed to make it on time by using buffer times and real-time distance. The VRP optimizations can minimize idle time for tourers and/or tour leaders. The tour can include various information (e.g. vehicle start and stop locations (e.g. homes and/or commercial real estate offerings); arrival and estimated leaving time interval for each pickup location (e.g. start and end times); drop-off/end time intervals; time spent at each location (e.g. considering the time it takes to tour a location). Process 700 can include functionalities solving, inter alia: linear programming (LP), mixed integer programming (MIP), constraint programming (CP), vehicle routing (VRP), and related optimization problems (e.g. using Google OR-Tools®, etc.). These can be applied to the VRP solutions generated.

In step 714, process 700 can optimize generated tour route to include a specified number of highest ranked elements of route matches.

Processes 600 and 700 can be optimized using VRP solutions and functionalities. Vehicle Routing Problem (VRP) can be described as the problem of creating a set of optimal routes/tours subject to a set of constraints. Here, there can be two set of constraints. A first constraint can be the original tour purpose (e.g. a set of homes for a real estate tour, etc.). A second constraint that can be used to update the output of a route planner based on the first constraint. This can be “Lifestyle Points of Interest”/information in data stores 602-604, 610-612, etc. Process 700 can provide solutions to the VRP that optimize the first constraint and then the update the optimizations using the second “Lifestyle Points of Interest” constraint set.

Example VRP solutions and functionalities are now provided. These can include, inter alia:
Vehicle Routing Problem with Time Windows (VRPTW): vehicles are required to visit locations during specific time windows requested by customers;
Capacitated Vehicle Routing Problem (CVRP): vehicles have a limited carrying capacity (weight or volume) of items; and/or
Vehicle Routing Problem with Pickup and Delivery (VRPPD): vehicles need to move items from certain pickup locations to other delivery locations.

Process 700 can use routing software that returns a solution that is good enough but not the best one. VRPs search space grows with respect to the problem size, finding an optimal solution becomes challenging. Process 700 can divide the problem into sub-problems. Hierarchical Approach Cluster First and Route Second (CFRS). For example, in the first stage customers are assigned to vehicles using the best-performing clustering algorithm (K-means, K-medoids, DBSCAN). In a second stage, Linear Programming (LP) is used to construct vehicle routes. Process 700 can apply a Route First and Cluster Second (RFCS) process. For example, process 700 can implement a Genetic Algorithm (GA) to create the route, then partition it and compare it in different scenarios, using clustering algorithms (e.g. K-means, K-medoids, K-modes). Process 700 can leverage various predictive models for VRP In VRP, customer demands, and vehicle travel time are not deterministic. Process 700 can learn to configure algorithms VRP algorithms have a great number of hyperparameters that need to be carefully adjusted to obtain a good performance. For example, clustering can be employed for fine-tuning a multi-lifestyle points of interest vehicle routing problem. Process 700 can enable manual review and updating by tour guide/coordinator.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

1. A computerized method for generating and using user profile-based routing machine-learned model(s) to optimize a route planner system:
providing a first data store of a plurality of historical user profile and a plurality of historical similar user profile data;
using the plurality of historical user profile data and the plurality of historical similar user profile data to train a user profile-based routing ML model;
providing a second data store of another plurality of historical user profile and another plurality of historical similar user profile data;
using the other plurality of historical user profile data and the plurality of historical similar user profile data to validate the user profile-based routing ML model;
obtaining a set of tour stops;
with at least one route planning and optimization algorithm, generating a tour route of the set of tour stops;
using the user profile-based routing ML model to identify a set of user profile affinity-based locations near the tour route; and
generating an updated tour route that include a portion of the set of user profile affinity-based locations near the tour route.

2. The computerized method of claim 1, wherein the machine-learned model comprises an artificial neural network model.

3. The computerized method of claim 1, wherein the machine-learned model comprises a deep learning model.

4. The computerized method of claim 1, wherein the historical user profile data comprises a historical user preference data and a plurality of historical user lifestyle data.

5. The computerized method of claim 4, wherein the historical use profile data comprises a user demographic data, a user spouse profile data, a user educational data, a user answers to an intake questionnaire, and data an input by an agent interviewing the user such that the agent updates the profile at a later time.

6. The computerized method of claim 5, wherein the historical similar user profile data comprises a historical similar user preference data and a plurality of historical similar user lifestyle data.

7. The computerized method of claim 6, wherein the historical similar use profile data comprises a similar user demographic data, a similar user spouse profile data, a similar user educational data, a similar user answers to an intake questionnaire, and data an input by an agent interviewing the similar user.

8. The computerized method of claim 7, where a similarity between the user and a selection of any similar user data is determined using a K-nearest neighbors algorithm.

9. The computerized method of claim 8 further comprising:
pushing the updated tour route to a user-side mobile device mapping application.

10. The computerized method of claim 9 further comprising:
displaying the updated tour route on the user-side mobile device mapping application.

11. A computer system useful for implementing a language neutral virtual assistant comprising:
a processor;
a memory containing instructions when executed on the processor, causes the processor to perform operations that:
provide a first data store of a plurality of historical user profile and a plurality of historical similar user profile data;
use the plurality of historical user profile data and the plurality of historical similar user profile data to train a user profile-based routing ML model;
provide a second data store of another plurality of historical user profile and another plurality of historical similar user profile data;
use the other plurality of historical user profile data and the plurality of historical similar user profile data to validate the user profile-based routing ML model;
obtain a set of tour stops;
with at least one route planning and optimization algorithm, generate a tour route of the set of tour stops;
use the user profile-based routing ML model to identity a set of user profile affinity-based locations near the tour route; and
generate an updated tour route that include a portion of the set of user profile affinity-based locations near the tour route.

12. The computerized system of claim 11, wherein the machine-learned model comprises an artificial neural network model.

13. The computerized system of claim 11, wherein the machine-learned model comprises a deep learning model.

14. The computerized system of claim 11, wherein the historical user profile data comprises a historical user preference data and a plurality of historical user lifestyle data.

15. The computerized system of claim 14, wherein the historical use profile data comprises a user demographic data, a user spouse profile data, a user educational data, a user answers to an intake questionnaire, and data an input by an agent interviewing the user.

16. The computerized system of claim 15, wherein the historical similar user profile data comprises a historical similar user preference data and a plurality of historical similar user lifestyle data.

17. The computerized system of claim 16, wherein the historical similar use profile data comprises a similar user demographic data, a similar user spouse profile data, a similar user educational data, a similar user answers to an intake questionnaire, and data an input by an agent interviewing the similar user.

18. The computerized system of claim 17, where a similarity between the user and a selection of any similar user data is determined using a K-nearest neighbors algorithm.
